(19) United States
(12) Patent Application Publication
(10) Pub. No.: US 2016/0088967 A1
(43) Pub. Date: Mar. 31, 2016

(54) Storage Device for Sinks

(71) Applicant: Peapea Moli, Aiea, HI (US)

(72) Inventor: Peapea Moli, Aiea, HI (US)

(21) Appl. No.: 14/858,499

(22) Filed: Sep. 18, 2015

Related U.S. Application Data
(60) Provisional application No. 62/055,324, filed on Sep. 25, 2014.

(51) Int. Cl. A47G 29/08; F16M 13/02; F16B 47/00

(52) U.S. Cl. CPC A47G 29/08; F16B 47/00; F16M 13/022

(57) ABSTRACT

A storage device to be placed over a kitchen sink for holding dish towels and cleaning supplies. The storage device includes a first upstanding support and a second upstanding support connected via a crossbar so as to form a U-shaped frame. The upstanding supports can be positioned on opposing sides of a sink so that the crossbar extends over the sink. Each upstanding support includes an arm extending perpendicularly therefrom, wherein the arms include fasteners for connection to a support surface, such as a wall. Further, baskets for holding cleaning supplies can be removably secured to the arms via a fastener thereon, such as a hook. The baskets include an interior volume and may include one or more dividers.

### CROSS REFERENCE TO RELATED APPLICATION

This application claims the benefit of U.S. Provisional Application No. 62/055,324 filed on Sep. 25, 2014. The above identified patent application is herein incorporated by reference in its entirety to provide continuity of disclosure.

### BACKGROUND OF THE INVENTION

### Field of the Invention

The present invention relates to a storage device for kitchen sinks. More specifically, the present invention provides a storage device comprising a frame having a pair of upstanding supports connected by a crossbar, wherein the crossbar is disposed horizontally and is adapted to hold dish towels thereon. The frame further includes an arm extending perpendicularly from each vertical support on which a basket can be removably positioned, wherein the basket is used for holding cleaning supplies, such as dish soap.

Kitchen sinks often become cluttered with dishes, cups, towels, and cleaning supplies, among other items. Dish towels can become damp when placed on the counter adjacent to the sink, and a damp dish towel can become moldy or musty. Further, dish soap and hand soap can consume counter space adjacent to the sink, which can be inconvenient. Thus, a device for providing additional storage space around a kitchen sink is desired.

Devices have been disclosed in the prior art that relate to sink organizing devices. These include devices that have been patented and published in patent application publications. U.S. Published Patent Application Number 2004/0099617 and U.S. Pat. No. 7,857,147 provide dish organizing racks or devices. Other devices relate to organizers for storing cleaning tools and supplies, such as U.S. Pat. No. 7,578,399, U.S. Pat No. 5,289,927, and U.S. Published Patent Application Number 2006/0289372.

These prior art devices have several known drawbacks. Such devices fail to provide a crossbar for storing dish towels thereon so as to allow the dish towel to dry. Further, the devices in the prior art do not disclose baskets for holding cleaning supplies that are removably securable to a U-shaped frame. Thus, while the prior art devices relate to dish organizers and storage racks, these devices do not provide means for storing dish towels and cleaning supplies over a sink.

In light of the devices disclosed in the prior art, it is submitted that the present invention substantially diverges in design elements from the prior art and consequently it is clear that there is a need in the art for an improvement to existing storage devices for sinks. In this regard the instant invention substantially fulfills these needs.

### SUMMARY OF THE INVENTION

In view of the foregoing disadvantages inherent in the known types of sink storage devices now present in the prior art, the present invention provides a new sink storage device wherein the same can be utilized for providing convenience for the user when storing dish towels and cleaning supplies in the area of a kitchen sink for convenient access thereto.

It is therefore an object of the present invention to provide a new and improved sink storage device that has all of the advantages of the prior art and none of the disadvantages.

It is another object of the present invention to provide a storage device for sinks comprising a U-shaped frame adapted to be disposed over a kitchen sink.

Another object of the present invention is to provide a storage device comprising a frame with a pair of upstanding supports connected by a crossbar, wherein the upstanding supports are disposed on opposing sides of a sink.

A further object of the present invention is to provide a storage device comprising a crossbar that connects a pair of upstanding supports and on which dish towels can be placed.

An additional object of the present invention is to provide a storage device comprising one or more baskets in which cleaning supplies can be positioned.

Yet another object of the present invention is to provide a storage device comprising supports having arms with fasteners securable to a support surface to help stabilize and support the storage device in an upright orientation.

Another object of the present invention is to provide a storage device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the storage device.

FIG. 2 shows a close-up view of a basket of the storage device.

FIG. 3 shows a perspective view of the storage device in position over a sink.

### DETAILED DESCRIPTION OF THE INVENTION

Reference is made herein to the attached drawings. Like reference numerals are used throughout the drawings to depict like or similar elements of the storage device. For the purposes of presenting a brief and clear description of the present invention, the preferred embodiment will be discussed as used for storing dish towels and cleaning supplies in an organized and easily accessible manner over a sink. The figures are intended for representative purposes only and should not be considered to be limiting in any respect.

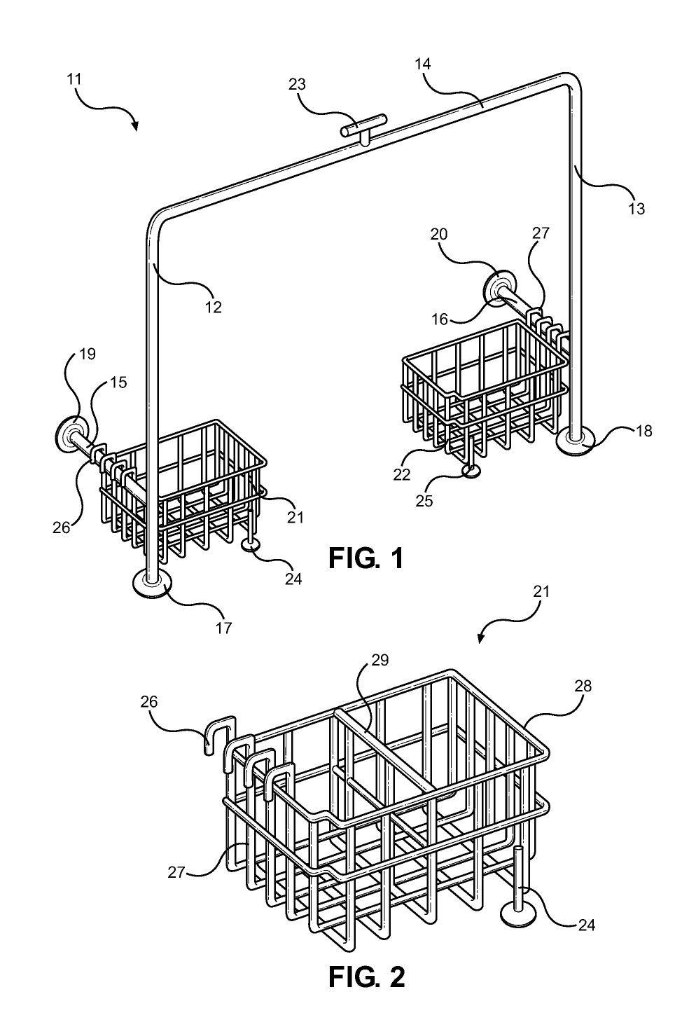

Referring now to FIG. 1, there is shown a perspective view of the storage device. The storage device 11 comprises a frame having a first upstanding support 12 and a second upstanding support 13 connected via a crossbar 14. The upstanding supports 12, 13 are parallel to one another and are adapted to be positioned in a vertical orientation. The lower end of each upstanding support 12, 13 includes a foot 17, 18 thereon respectively, for helping to balance and stabilize the storage device 11 in an upright orientation.

The crossbar 14 is connected to the upper end of each upstanding support 12, 13 and is disposed perpendicularly to the upstanding supports 12, 13 such that it is in a horizontal orientation. In this way, the frame comprises a U-shape. The upstanding supports 12, 13 and crossbar 14 can include tubular members or rods, and are preferably composed of a lightweight and corrosion resistant material. The crossbar 14 may include one or more hooks 23 for helping to secure a dish towel or other item thereon.

The first upstanding support 12 includes a first arm 15 thereon. Similarly, the second upstanding support 13 includes a second arm 16 thereon. The arms 15, 16 extend outward from the supports 12, 13. The arms 15, 16 are preferably perpendicular to the supports 12, 13 and the arms 15, 16 are parallel to one another. Each arm 15, 16 includes a fastener 19, 20 on an end thereof adapted to secure the arm 15, 16 to a support surface, such as a wall. In a preferred embodiment, the fastener 19, 20 is a suction cup, however in alternate embodiments the fastener can be a bracket that is securable to a support surface via screws, bolt, nails, or the like.

The storage device 11 further comprises one or more baskets 21 removably securable to the arms 15, 16 of the frame. The baskets 21 are adapted to receive cleaning supplies or the like therein, and include fasteners 26, 27 thereon for removably securing the same to the arms 15, 16.

Referring now to FIG. 2, there is shown a close-up view of a basket of the storage device. The basket 21 comprises a base, one or more sidewalls, and an open upper end, defining an interior volume. The basket 21 is preferably composed of wire such that water or other liquid can drain from the interior volume of the basket 21. The interior volume may be divided into one or more compartments by dividing walls 29. The interior volume is adapted for storage of cleaning supplies such as dish detergent bottles, hand soap containers, and the like. The lower end of the basket 21 includes a support leg 24 adapted to contact a support surface, such as the counter adjacent to a sink, in order to stabilize the basket 21. The support leg 24 is preferably positioned along a front wall of the basket 21. The support leg 24 may include a foot thereon, or may include a suction cup on the lower end thereof. Further, the upper end of a side of the basket 21 includes a fastener 26, such as one or more hooks, for removably securing the basket 21 to an arm of the storage device. The basket 21 is preferably composed of a lightweight and corrosion resistant material.

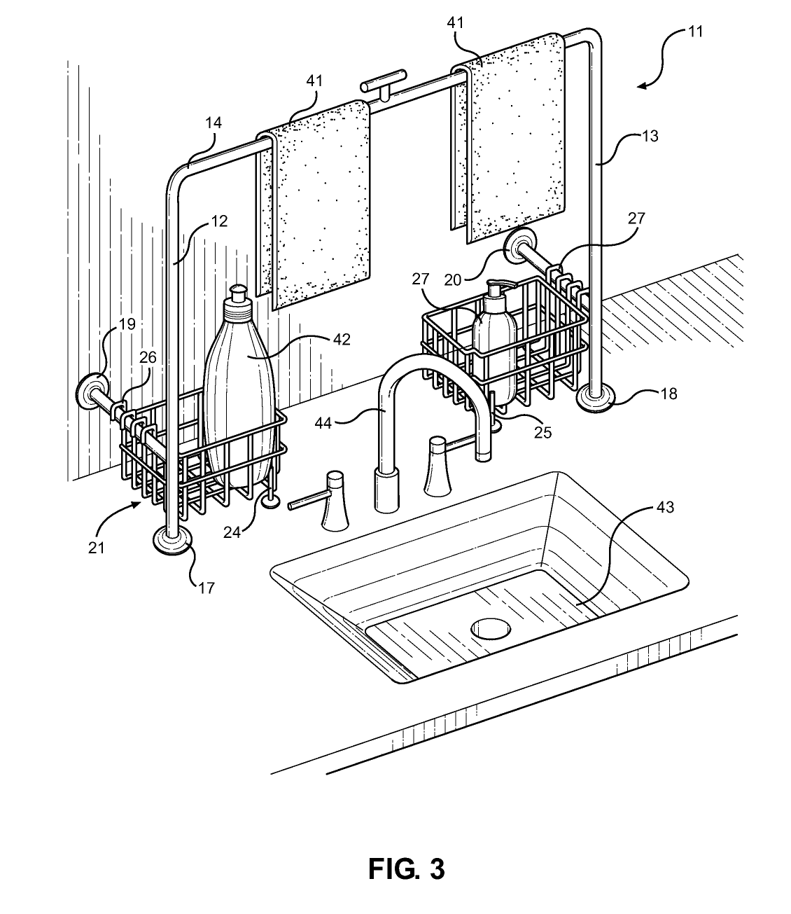

Referring now to FIG. 3, there is shown a perspective view of the storage device in position over a sink. The storage device 11 can be positioned over a sink 43 such that the first upstanding support 12 is disposed on a first side of the sink 43, and the second upstanding support 13 is disposed on the opposing side of the sink 43. The upstanding supports 12, 13 are of sufficient height such that the crossbar 14 does not interfere with the faucet 44 of the sink 43. The crossbar 14 is adapted to hold one or more dish towels 41 thereon for convenient access to the dish towels 41 and so as to allow the dish towels 41 to dry.

The arms 15, 16 of the storage device 11 are secured to the wall behind the sink 43 via the fasteners 19, 20 thereon. Further, the baskets 21 are removably positioned on the arms 15, 16 and can hold cleaning supplies 42 therein. The baskets 21 are positioned on opposing sides of the faucet 44 and are spaced so as to not interfere with or contact the faucet 44. The support legs 24, 25 of the baskets 21 contact a portion of the counter surrounding the sink 43 so as to help stabilize the baskets 21 and the items therein.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A storage device for kitchen sinks, comprising:
a first upstanding support and a second upstanding support, wherein said first upstanding support and said second upstanding support are connected via a crossbar so as to form a U-shaped frame;
a first arm disposed on said first upstanding support;
a second arm disposed on said second upstanding support;
wherein each of said first arm and second arm comprise a fastener adapted to secure said first arm and said second arm to a support surface;
one or more baskets removably securable to said first arm or said second arm.

2. The storage device of claim 1, wherein each of said first upstanding support and said second upstanding support comprises a foot on a lower end thereof.

3. The storage device of claim 1, wherein said fastener on said first arm and on said second arm comprises a suction cup.

4. The storage device of claim 1, wherein said first arm is perpendicular to said first upstanding support, and wherein said second arm is perpendicular to said second upstanding support.

5. The storage device of claim 1, wherein said one or more baskets each comprises a base, one or more sidewalls, and an open upper end, wherein said one or more sidewalls includes a fastener removably securable to said first arm or said second arm.

6. The storage device of claim 5, wherein said fastener includes one or more hooks.

7. The storage device of claim 5, wherein said one or more baskets are composed of wire.

8. The storage device of claim 5, wherein said one or more baskets further include a support leg thereon adapted to contact a support surface.
